(19) United States
(12) Patent Application Publication
(10) Pub. No.: US 2004/0174026 A1
(43) Pub. Date: Sep. 9, 2004

(54) Sanitary waste collection device

(76) Inventor: Andre Sampaio, Blauvelt, NY (US)

Correspondence Address: Stephen E. Feldman, P.C., 12 East 41st Street, New York, NY, 10017, US

(21) Appl. No.: 10/383,914

(22) Filed: Mar. 7, 2003

(51) Int. Cl. A01K 29/00; E01H 1/12

(52) U.S. Cl. 294/1.4

(57) ABSTRACT

A waste collection device and method of operation is described. The device has a handle, housing, and a collection mechanism. A trigger of the collection mechanism is pulled to actuate a rod to reposition a pair of hands adapted for the positioning of a bag. The pulling of the trigger drives the rod distally and extends a pair of levers to move the hands from a closed position to an open position. A method is included wherein the hands are adapted for use with a bag. The bag is inverted and positioned at least partially over the hands. The trigger is pivoted towards the handle and the hands open for the positioning of the distal ends of the hands on opposing sides of the waste. Releasing the trigger closes the hands and secures the waste within the bag. The edges of the bag can then be grasped by the user and the bag returned to a normal position with the waste secured therein.

### BACKGROUND

1. Technical Field

The present disclosure relates to sanitary waste collection devices and, more particularly, to sanitary waste collection devices adapted for use with bags for the containment of objects such as animal waste.

2. Background of Related Art

Sanitary waste collector configurations typically include a handle connected to a collection device. The handles are often connected to an actuation mechanism for securing the sanitary waste between grasping elements of the collection devices. The grasping elements can be shaped as scoops or plates capable of securing the waste within the collector. Alternately waste collector configurations include boxes or bags connected to a portion of the actuation mechanism which act partially or completely as the grasping mechanism.

In U.S. Pat. No. 3,446,525 to L. M. Jones, a sanitary pickup device for animal dropping is described including an elongate body portion having pickup means positioned at the lower end. The pickup means includes a pair of movable open frame pickup members adapted to carry a sanitary disposable wrapper or bag. The movable open frame members are configured for the ease of positioning and removal of the bag. A trigger, having a limited range of motion is positioned in proximity to the handle and is fixedly connected to an upper end of a rod. The bottom end of the rod is pivotally connected to a pair of transversely aligned and upwardly extending short links. Each short link is connected to a U-shaped crank arm portion of each pickup member. Each pickup frame member is fabricated of bent wires positioned in a first plane except for the shaped crank arm portion which extend transversely in a second plane from the plane. When the trigger is translated vertically or pulled into the handle raising the rod, the short links pivot outwardly and drive the crank arms from being in proximity to a center line of the device to an outward position thereby spreading the pickup members apart. The pickup members are resiliently urged to a closed position by a coiled spring positioned in the body part and through which the rod is positioned; when the handle is pulled vertically, the coil spring is compressed providing a bias to extend the rod to the closed position.

While Jones provides an effective actuating mechanism, it is limited in the size of objects it can pick up by the downward extension of the rod, short links, and U-shaped crank arms extending into the area of collection of the pickup members and thereby potentially limiting the size of objects that can be removed. Additionally, the downward extension of the rod and corresponding length of the short links limits the angular range of motion of the pickup members. Further, the connections between the rod, short links, and crank arms as well as the pickup member and U-bracket are unnecessarily exposed to the weather conditions experienced by the user. This reduces the reliability and would require additional maintenance over time to keep the pickup device from difficult or inoperable to use.

A sanitary waste collector is described in U.S. Pat. No. 5,620,220 to Khoshnood and includes two substantially planar braces connected at their top by a hinge. The braces define aligned through holes abutting the hinge and a handle is positioned between the braces. The braces each have a U-shaped rod defining a downward edge opposing the hinge configured for collecting waste. The handle is connected to a first planar body centrally positioned between the planar braces defining a vertical longitudinal axis that is connected with a second pair of planar bodies at an angle transverse to the vertical on one end and to each of the braces on the other end. The braces are biased to a closed position. When the handle is pulled towards the hinge, the first planar body is moved vertically pushing the two second planar bodies outward opening the braces of the waste collector. A deformable and biodegradable enclosure is provided for use with the collector. The device is stated as being between one and two feet in length.

Khoshnood is limited, however, by the first and second planar bodies which are configured similarly to the rod and short links of Jones and therefore have the shortcomings of size of objects to be picked up and range of motion of the combination of the planar braces and U-shaped rods as identified above. Thus, in this device, the size of the enclosure configured for attachment with the planar braces is limited by the downward extension of the first planar body. Khoshnood also uses a deformable biodegradable enclosure that requires a specialized purchase and would function marginally if at all in a heavy or downpour. Further, Khoshnood, can represent a safety risk by capturing portions of a user's hand between the planar braces in the vicinity of the hinge/handle as they close. Finally, the Khoshnood planar mechanism would not readily adapt to a walking stick sized device and is limited in length. This requires the user to bend over or kneel down to effectively use the device.

A sanitary pickup device is described in U.S. Pat. No. 6,068,311 to G. K. Jones having a handle integrally formed with an opposing pickup means. The pickup means includes a pair of open frame pickup members or bail frames adapted to collect and carry sanitary waste in a flexible bag. The pickup means is operable by exercising a pivoting trigger associated with the handle move the control actuator means. The control actuator means includes an elongate rod connected to the bail frame. The bail frames are fabricated of wire defining a first plane with one of the bail frames having a V-shaped bend that connects with the rod. The V-shaped bend defines a second plane transverse to the first plane. The trigger only actuates the bail frame with the V-shaped bend, the other bail frame being fixed in position.

Jones is limited in the size of objects it can pick up by the limited range of motion of the pivotal trigger and therefore limited downward extension of the rod. Further, the downward extension of the rod and V-shaped bend into the area of collection of the bail frames limits the size of objects that can be removed. Additionally, the downward extension of the rod and corresponding length of the V-shaped band limits the angular range of motion of the pickup members. Finally, the connections between the rod and V-shaped bend are unnecessarily exposed to the weather conditions experienced by the user. This reduces the reliability and would require additional maintenance over time to keep the pickup device from difficult or inoperable to use.

A continuing need exists for a sanitary collection device adapted for use with a bag having a simplified actuation structure and a collection mechanism having an improved angular range of motion suitable for collecting a wide range of sizes of waste.

### SUMMARY

A waste collector configured for picking up waste materials is described that is adapted for use with a removably positionable bag for retaining the waste materials. The waste collector comprises a waste collection device having a handle. The handle is connected to a housing having a proximal end portion and a distal end portion. The proximal end portion is connected to the handle. The housing includes a tubular shaft. A collection mechanism is at least partially positioned in the housing and handle and includes a means for extended pivoting. The means for extended pivoting is configured for moving the collection mechanism between a first position and a second position and is at least partially positioned in the handle. A bias means is positioned to urge the collection mechanism to the first position. The handle and the means for extended pivoting are adapted for use by the hand of a user, the trigger is configured for pivotal movement relative to the handle. A rod is positioned in the tubular shaft and the rod has a proximal end portion and a distal end portion. The proximal end portion of the rod is pivotally connected to means for extended pivoting. A pair of hands is included in the device with each hand having a distal end portion and a proximal end portion. The distal end portions of the hands are adapted for use with a bag suitable for collecting waste. The proximal end portions are pivotally connected and positioned in the housing. A pair of levers are pivotally connected to the distal end of the rod, the levers extending distally from the rod and being pivotally connected on their opposing ends with the proximal end portions of the hands such that the hands are driven between a closed position and an open position by the movement of the trigger between the first and second positions.

The invention, together with attendant advantages, will be best understood by reference to the following detailed description of the invention when used in conjunction with the figures below.

### BRIEF DESCRIPTION OF THE DRAWINGS

Preferred embodiments of the presently disclosed three position headpiece are described herein with reference to the drawings, wherein:

FIG. 1 is a first partial cut away perspective view along a longitudinal axis of one preferred embodiment of the waste collection in a first position depicting portions of the hands and constructed in accordance with the present disclosure;

FIG. 2 is a second partial cut away perspective view along the longitudinal axis of one preferred embodiment of the waste collection device of FIG. 1 in a second position constructed in accordance with the present disclosure;

FIG. 3 is a cross sectional perspective view along the longitudinal axis of a handle of the waste collection device of FIG. 1 in the first position;

FIG. 4 is a cross sectional perspective view along the longitudinal axis of a handle of the waste collection device of FIG. 1 in the second position;

FIG. 5 is a partial cut away perspective view along the longitudinal axis of one preferred embodiment of the hands of the waste collection device of FIG. 1 in a first position depicting constructed in accordance with the present disclosure; and

FIG. 6 is a second partial cut away perspective view along the longitudinal axis of one preferred embodiment of the hands of the waste collection device of FIG. 1 in a second position constructed in accordance with the present disclosure.

### DETAILED DESCRIPTION OF THE EMBODIMENTS

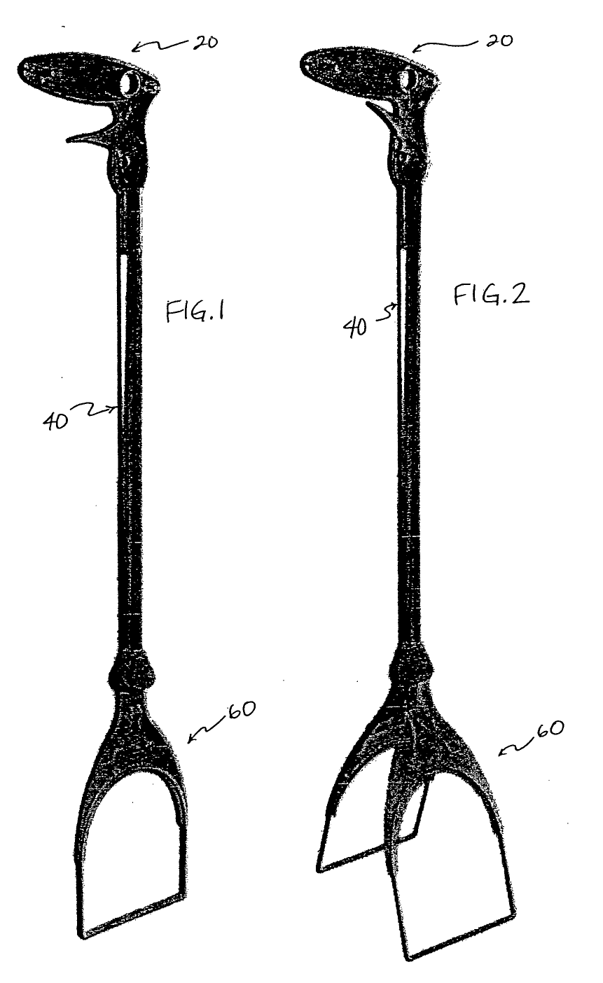

Referring now in specific detail to the drawings in which like referenced numerals identify similar or identical elements throughout the several views, and initially to FIGS. 1-2, a novel sanitary collection device 10 having a handle 20, housing 40, and a collection mechanism 60 is shown constructed in accordance with the present disclosure. Sanitary collection device 10, hereinafter referred to as “device 10” is intended for use by a person as a waste collecting for waste such as, but not limited to, animal waste having a broad range of sizes. Device 10 defines a longitudinal axis-X.

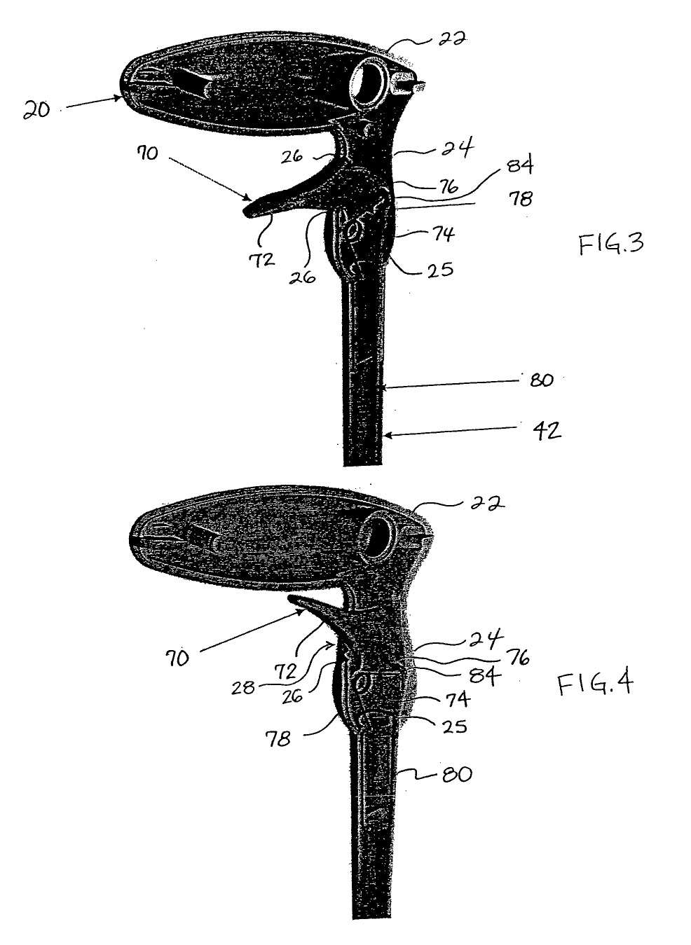

Referring now to FIGS. 3-4, handle 20 has a first portion 22 and a second portion 24. First portion 22 is an elongate portion having a generally elliptical cross section. First portion 22 is configured at least partially as a gripping device ergonomically suitable for use by a hand of a user. A major axis of the elliptical first portion defines a second longitudinal axis-Y transverse to axis-X. First portion 22 is connected to second portion 24 being generally aligned with axis-X.

Second portion 24 has a generally tubular shape with a tapered center section positioned between bulbous proximal end and distal end portions. Second portion 24 defines a rim 26 for an elongate hole or slot 28 and a cavity 30 therein. Slot 28 is directionally oriented towards first portion 22. Rim 26 and hole 28 can also include a seal configured to at least partially seal hole 28 from inclement weather conditions. Second portion 24 of handle 20 is connected to housing 40.

Housing 40 includes a tubular shaft 42 and an axis housing 50. Tubular shaft 42 is an elongate shaft having a distal end 44 and a proximal end 46. Tubular shaft 42 is centered upon and aligned with longitudinal axis-X. Distal end 44 is connected to axis housing 50 and proximal end 46 is connected to handle 20. Housing 40 provides structural support for collection mechanism 60. In one preferred embodiment, shaft 20 has a tubular wall 48 defining a through hole. Tubular shaft 42 in one preferred embodiment has a length suitable to support an overall length of device 10 in a range of approximately one to four feet.

Axis housing 50 has a distal end portion 52 and a proximal end portion 54. Proximal end portion 54 is connected with distal end 44 of tubular shaft 42 and has in one preferred embodiment a rounded frustum of a right circular cone shape aligned with longitudinal axis-X. It is recognized, however, axis housing 50 can have any shape suitable for a housing. Axis housing 50 functions in cooperation with tubular shaft 42 and handle 20 to provide a protective cover or housing for collection mechanism 60 configured to provide a generally water resistant enclosure. Housing 40 can be fabricated from one or more plastics, composites, or metals.

Collection mechanism 60 includes means for extended pivoting 70, a rod 80, and a pair of hands 90. Collection mechanism 60 is configured to support the movement of device 10 between a first position and a second position by the actuation of means for extended pivoting 70.

Means for extended pivoting or trigger 70 is configured for extending the range of motion of hands 90 while using a minimal displacement along longitudinal axis-X. Means for extended pivoting 70 includes a first or trigger portion 72, a pivoting portion 74, an attachment means 76, and a bias means 78. First portion 72 in one preferred embodiment is a relatively short elongate tapered member having a plate shaped terminal end, but first portion 72 can be any shape or length suitably adapted for grasping by one or more fingers of the hand of the user. A shorter trigger portion 72 can advantageously accommodate a greater range of pivotal movement before being interrupted by first portion 22. Trigger portion 72 is positioned in proximity to handle first portion 22 such that the fingers of a user can readily grasp and draw trigger portion 72 towards first portion 22. Pivoting portion 74 is positioned between first portion 72 and attachment means 76.

In one preferred embodiment, second portion 24 is configured to accommodate an increased range of rotation by means for extended pivoting 70 within second portion 24. The increased pivotal range of motion of means for extended pivoting 70 is enhanced by one preferred embodiment wherein means for extended pivoting 70 has a modified bellcrank configuration with trigger portion 72 and attachment means 76 defining a line. Pivoting portion 74 is positioned between trigger portion 72 and attachment means 76 and distal to the line defined by portion 72 and means 76. Pivoting portion 74 pivots about a pivotal axis 25 positioned on second portion 24 distal to hole 28. Thus, means for extended pivoting or trigger 70 has a generally triangular shaped bellcrank type configuration pivoting about pivoting portion 74. This configuration accommodates an increased pivotal range of trigger 70, which corresponds to an increased longitudinal displacement of rod 80. The increased displacement of rod 80 equates to an increased transverse displacement of levers 96 relative to longitudinal axis-X which thereby increases the angular range of motion of hands 90. The range of angular motion of trigger 70 is limited by the proximal and distal positions of rim 26.

Alternative means for extended pivoting 70 includes circular or elliptical configurations of pivoting portions 74 and attachment means 76. When connected with rod 80, such configurations can move attachment means 76 and rod 80 through a range of motion of up to approximately 180 degrees by the movement of an appropriately positioned trigger portion 72.

Trigger 70 is suitable for being at least partially positioned in hole 28 and cavity 30 of handle 20. Second portion 74 is pivotally connected to second portion 24 and is configured to provide for the movement of trigger 70 between a first and a second position. In one preferred embodiment, pivot portion 74 is positioned between trigger portion 72 and attachment means 76 so as to define a generally triangular shape between the three portions. In a further preferred embodiment, second or pivoting portion 74 defines a hole and second portion 24 of handle 20 defines a cylindrical rod configured as an axis of rotation and for positioning in the hole defined in the second portion.

Bias means 78 is configured to bias collection mechanism 60 to the first position. In one preferred embodiment, bias means 78 is a leaf spring positioned on the pivotal connection of trigger 70 with second portion 24 and suitable force for positioning collection mechanism 60 in the first position from the second position. Alternate embodiments of bias means 78 include coiled springs, other leaf spring configurations, or resilient materials configured to provide a bias having suitable force to return collection mechanism 60 to the first position. It is also envisioned bias means 78 could be positioned directly between trigger 70 and alternative positions in housing 40 or handle 20.

Attachment portion 76, positioned opposing first portion 72, provides a pivotal connection with rod 80. It is readily envisioned that the configuration of trigger 70 could be positioned in a number of positions on or in handle 20 and housing 40 for manipulation by a user's palm, thumb, and/or fingers, for example. Trigger 70 is preferably a monolithically formed member fabricated of one or more plastics, composite materials, or metals.

As shown in FIGS. 1-6, rod 80 is an elongate cylindrical member having a distal end portion 82 and a proximal end portion 84. Rod 80 extends from handle 20 through tubular shaft 42, axis housing 50, and a predetermined minimized distance between hands 90. Distal end portion 82 is pivotally connected to hands 90. In one preferred embodiment distal end portion 82 includes a U-shaped portion perpendicular to the longitudinal axis. In this embodiment, a distal most arm of the U-shaped portion provides an axis for the pivotal movement of hands 90. Proximal end portion 84 is pivotally connected with attachment means 76. In one preferred embodiment, proximal end portion 84 has an inverted “L” shape and attachment means 76 defines a hole 79 configured for receiving and accommodating the pivoting of proximal end 84 during the movement of trigger 70 from the first position to the second position. Bias means 78, in this one preferred embodiment, is configured as a leaf spring with a first spring end positioned against the proximal end 84 in the vicinity of trigger 70 and a second end positioned in direct contact handle 20 or housing 40. Rod 80 is preferably made of one or metals, but it could be fabricated from any material having suitable structural integrity including plastics and composite materials.

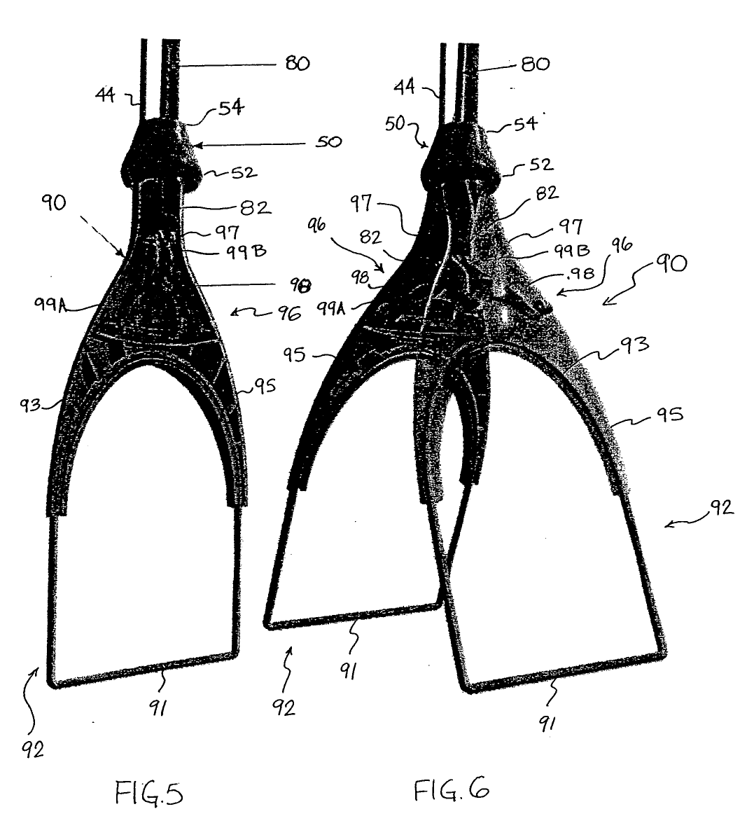

Referring now to FIGS. 5-6, hands 90 are adapted for use with a bag 100 and configured for retrieving waste. Hands 90 have a distally positioned first portion 92 and a proximally positioned second portion 96. First portions 92 are elongate members defining a structure suitable for collecting waste. A proximal end 93 of first portion 92 has two elongate wire or rod shaped extensions connected with second portion 96 on one end and a flat edged distal end 91 on the opposing ends. Distal end 91 is approximately perpendicular to longitudinal axis-X and has a generally flat wire or rod type shape suitable for scooping waste.

Second portions 96 have a generally flat plate shape at least partially enclosing the connection of rod 80 to hands 90. Second portions 96 are pivotally connected at their proximal ends 97 and pivotally attached to distal end portion 44 of tubular shaft 42. The distal ends 95 of second portions 96 are connected with first portions 92. Proximal ends 97 of second portion 96 are at least substantially encapsulated by axis housing 50.

In one preferred embodiment, second portion 96 and first portions 92 are connected together at their respective distal ends 95 and proximal ends 93. Second portions 96 have a flat planar shape with a tapered proximal end 97 and a distal end 95 having a U-shaped generally arcuate cut out defining two arms. First portions 92 include a U-shaped proximal end 93 such that first portions 92 define a through hole. The U-shaped proximal end 93 corresponds to the U-shape of distal end 95 such that the arms extend distally and are at least partially connected with the elongate extensions of first portion 92. The length of the connection between the elongate arms of second portion 96 and the elongate extension of first portion 92 is a suitable distance to provide additional rigidity and structural integrity to the wire of distal end portion 92 for its waste collection function. Preferably first portion 92 is a metal, metal alloy, plastic, or composite wire and second portion 96 is a monolithically formed assembly fabricated of one or more metals, plastics, or composites.

In another preferred embodiment, first portion 92 and second portion 96 are a monolithically formed assembly. This configuration can advantageously create a single inexpensive assembly having suitable structural integrity for functioning as a collector of waste. The monolithically formed hands 90 may be fabricated of one or more metals, plastics or composites.

Thus, while first portion 92 and second portion 96 can be separate assemblies integrated together, it is also envisioned that first portion 92 and second portion 96 can be monolithically formed as a single assembly. In this additional embodiment, the first and second portions could be fabricated of one or more metals, plastics, or composites.

Hands 90 are positioned in opposition with each other and proximal ends 93 are also pivotally connected to distal end 82 such that the distally directed displacement of rod 80 drives hands 90 apart to a predetermined angle. In a first position, hands 90 are preferably generally parallel and aligned with longitudinal axis-X. In one preferred embodiment, levers 98 extend distally from and are pivotally connected with distal end 82 to portions of proximal end portions 94. Thus, rod 80 is connected to levers 98 and does not extend distally beyond levers 98 between the first and second positions.

Levers 98 have a distal pair of arms 99A and a proximal pair of arms 99B. Distal arms 99A are pivotally connected with proximal end 94 and proximal ends 99B are pivotally connected to distal end 82. In one preferred embodiment, levers 98 have a generally triangular frame shape wherein proximal ends 99B are narrowly spaced and defining an apex of the triangular shape. Proximal arms 99B are configured such that the arms of levers 98 can be alternately spaced on the axis of rotation defined by distal end 82. Distal arms 99A are spaced wider than proximal arms 99B and define a base of the general triangular frame shape connected at proximal end 94. In this one preferred embodiment, distal arms 99A have a semicircular or arcuate shape connected along the arcuate shape with the pair of elongate tapered proximal arms 99B.

The angle defined by hands 90 in the second position is dependent upon factors such as the displacement of rod 80, configuration of means for extended pivoting 70, the position of the connection of lever 98 with proximal end 94, and the length of lever 98. For example, in one preferred embodiment, levers 98 have an equal length, are positioned at equivalent points along the longitudinal axis, and therefore spread each hand 90 an equivalent distance. It is envisioned, however, that levers 98 are configured for ease of removal and replacement and a range of lengths of lever 98 are included in device 10 so as to vary the range of movement of each hand from being fixed in position to a second position wherein one or both of hands 90 are approaching a 90 degree displacement from the first position.

Referring now to FIGS. 1-6, in operation device 10 is adapted for use with bag 100, preferably made of one or more plastic materials. Bag 100 is inverted and loosely positioned over distal ends 92. The ends of bag 100 can be removably attached to device 10 using a rubber band positioned on distal end 46 or integrally positioned with a groove perpendicular to longitudinal axis-X positioned in axis housing 50, for example. Bag 100 can be positioned over distal end 92 with device 10 at any point between the first and second positions.

Device 10 collects waste by the user pivoting trigger 70 from the first position to the second position thereby extending rod 80 distally and driving levers 98 to extend outward from longitudinal axis-X to open hands 90 to a predetermined angle. The waste to be collected is positioned between hands 90 with the distal ends of the hands positioned against the surface upon which the waste is positioned. When trigger 70 is released, bias means 78 drives rod 80 and levers 98 proximally thereby moving the distal ends 91 of hands 90 from the second position to the first position of collection mechanism 60 securing the waste within bag 100. The user then grasps and repositions the ends of bag 100 to secure the waste therein. The trigger may have to be actuated to open the hands to remove the bag and waste depending upon the size of the waste and the positioning of the bag; this can be done by the user directly manipulating hands 90 or by using trigger 70. As required, another bag can then be inverted onto hands 90 and device 10 employed again as needed.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. All such changes and modifications are intended to be included within the scope of the disclosure.

What is claimed is:

1. A waste collector configured for picking up waste materials adapted for use with a removably positionable bag for retaining the waste materials, the waste collector comprising:
a waste collection device including a handle;
a housing including a tubular shaft, the housing having a proximal end portion and a distal end portion, the proximal end portion being connected to the handle; and
a collection mechanism including means for extended pivoting, bias means positioned to urge the collection mechanism to the first position, the handle and means for extended pivoting being adapted for use by the hand of a user, the mans for extended pivoting being configured for movement relative to the handle,
a rod having a proximal end and a distal end, the proximal end being pivotally connected to means for extended pivoting,
a pair of hands, each hand having a distal end portion and a proximal end portion, the distal end portion being adapted for use with a bag suitable for collecting waste, the proximal end portions being pivotally connected and positioned in the housing, a pair of levers pivotally connected to the distal end of the rod, the levers extending distally from the rod and being pivotally connected on their opposing ends with the proximal end portions of the hands such that the hands are driven between a closed position and an open position by the movement of mans for extended pivoting between the first and second positions.

2. The waste collector of claim 1, wherein the proximal end portion of the tubular shaft is connected to an axis housing.

3. The waste collector of claim 1, wherein the housing includes an attachment mechanism configured for securing a portion of the bag adapted for use with the hands to the housing.

4. The waste collector of claim 1, wherein means for extended pivoting includes a trigger, the trigger being configured for pivoting the collection mechanism between a first position and a second position, the trigger being at least partially positioned in the handle, the trigger including a trigger portion, a pivoting portion, and an attachment means, the pivoting portion being centrally positioned between the trigger portion and the attachment portion, the trigger portion, the pivoting portion, and the attachment portion define a generally triangular angular relationship.

5. The waste collector of claim 4, wherein the handle includes a pivot, the pivot portion being configured to pivot about the pivot, bias means being configured as a leaf spring, the leaf spring being connected to the pivot and having a first end positioned against the handle and a second end position against the proximal end of the rod, the leaf spring being configured to urge the collection mechanism to the first position.

6. The waste collector of claim 1, wherein the housing is configured to provide a water resistant enclosure, the axis housing is configured to at least partially enclose the pivotally connected proximal end portions of the handle.

7. The waste collector of claim 1, wherein the proximal end of the rod has an “L” shape and defines a pivotal axis for means for extended pivoting.

8. The waste collector of claim 1, wherein the distal end portion of the rod includes a “U” shaped portion configured as a pivotal axis for the levers.

9. A waste collector configured for picking up waste materials adapted for use with a hand of a user, the device being adapted for use with a removably positionable bag for retaining the waste materials, the device comprising:
a waste collection device including a handle;
a housing including a tubular shaft, the housing having a proximal end portion and a distal end portion, the proximal end portion being connected to the handle; and
a collection mechanism including a trigger, the trigger being configured for moving the collection mechanism between a first position and a second position, the trigger being at least partially positioned in the handle, the trigger including a centrally positioned pivot portion positioned between a trigger portion, and an attachment portion positioned on a side of the pivot portion opposing the trigger portion,
an elongate rod having a proximal end and a distal end, the proximal end being pivotally connected to the attachment portion, a bias means positioned at least partially in the handle to bias the collection mechanism to the first position, the handle and the trigger being adapted for use by the hand of a user, the trigger being configured for pivotal movement relative to the handle,
a pair of hands, each hand having a distal end portion and a proximal end portion, the proximal ends being pivotally connected and positioned in the housing, a pair of levers pivotally connected to the distal end of the rod, the levers extending distally from the rod and being pivotally connected on their opposing ends with the hands such that the hands are driven between a closed position and an open position by the movement of the trigger between the first and second positions.

10. The waste collector of claim 9, wherein the housing includes an attachment mechanism configured for securing a portion of the bag adapted for use with the hands to the housing.

11. The waste collector of claim 9, wherein the attachment portion of the trigger defines a hole, a proximal end of the rod having an “L” shape configured as an axis for being received in the hole of the attachment portion.

12. The waste collector of claim 9, wherein the handle includes a pivot, the pivot portion being configured to pivot about the pivot defined in the handle, bias means including a leaf spring connected to the pivot and having a first end positioned against the handle and a second end position against the proximal end of the rod, the leaf spring being configured to urge the collection mechanism to the first position.

13. The waste collector of claim 9, wherein the housing is configured to provide a water resistant enclosure, the axis housing is configured to at least partially enclose the pivotally connected proximal end portions of the handle.

14. The waste collector of claim 9, wherein the proximal end of the rod has an “L” shape and defines a pivotal axis for the attachment portion.

15. The waste collector of claim 9, wherein the distal end portion of the rod includes a “U” shaped portion configured as a pivotal axis for the levers.

16. The waste collector of claim 9, wherein the housing includes an axis housing, the axis housing being connected to the distal end of the tubular shaft, the axis housing providing an enclosure for the pivotal connection of the proximal end portions of the hands and the connection of the hands to the distal end of the tubular shaft.

17. A device for picking up waste materials adapted for use with a hand of a user, the device being adapted for use with a removably positionable bag for retaining the waste materials, the device comprising:
a waste collection device including a handle;
a housing including a tubular shaft and an axis housing, the housing having a proximal end portion and a distal end portion, the proximal end portion being connected to the handle, the distal end being connected to the axis housing; and
a collection mechanism including a trigger, the trigger being configured for moving the collection mechanism between a first position and a second position, the trigger being at least partially positioned in the handle, the trigger including a centrally positioned pivot portion positioned between a trigger portion, and an attachment portion positioned on a side of the pivot portion opposing the trigger portion, the attachment portion of the trigger defining a hole, the attachment mechanism, trigger portion, and pivotal portion having a triangular relationship,
an elongate rod having a proximal end and a distal end, the proximal end being pivotally connected to the actuator portion, a leaf spring positioned between the tubular shaft and the proximal end of the rod to bias the lever to a first position, the handle and the trigger being adapted for use by the hand of a user, the trigger being configured for pivotal movement relative to the handle, a proximal end of the rod being configured as an axis for pivotal rotation, the proximal end of the rod being positioned in the hole of the attachment portion,
a pair of hands, each hand having a distal end portion and a proximal end portion, the proximal ends being pivotally connected and positioned in the axis housing, a pair of levers pivotally connected to the distal end of the rod, the levers extending distally from the rod and being pivotally connected on their opposing ends with the hands such that the hands are driven between a closed position and an open position by the movement of the trigger between the first and second positions.

18. The waste collector of claim 17, wherein the handle includes a pivot, the pivot portion being configured to pivot about the pivot defined in the handle, bias means including a leaf spring connected to the pivot and having a first end positioned against the handle and a second end position against the proximal end of the rod, the leaf spring being configured to urge the collection mechanism to the first position.

19. The waste collector of claim 17, wherein the proximal end of the rod has an “L” shape configured as an axis for being received in the hole of the attachment portion, the distal end portion of the rod including a “U” shaped portion configured as a pivotal axis for the levers.

20. The waste collector of claim 20, wherein the housing is configured to provide a water resistant enclosure, the axis housing is configured to at least partially enclose the pivotally connected proximal end portions of the handle.
